(19) United States
(12) Patent Application Publication
(10) Pub. No.: US 2002/0059586 A1
(43) Pub. Date: May 16, 2002

(54) Method and system for personalization and authorization of interactive television content

(76) Inventors: John Carney, Sausolito, CA (US); Ranjit Sahota, Fairfax, CA (US)

Correspondence Address: Sang Hui Michael Kim, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/841,423

(22) Filed: Apr. 23, 2001

Related U.S. Application Data
(60) Provisional application No. 60/199,686, filed on Apr. 24, 2000.

(51) Int. Cl. H04N 7/025

(52) U.S. Cl. 725/35

(57) ABSTRACT

A method and system are disclosed for personalization authorization of interactive television content. In one embodiment, interactive television (TV) content is tagged with one or more keys or personalization data. The tagged interactive TV content is transmitted to one or more receivers such that the receivers are to output or make use of selectively the interactive TV content based on the keys

### RELATED APPLICATION

This application is related to and claims priority to U.S. Provisional Application No. 60/199,686 entitled, “METHOD AND SYSTEM FOR TRANSFORMING CONTENT FOR EXECUTION ON MULTIPLE PLATFORMS,” filed on Apr. 24, 2000, the disclosure of which is hereby incorporated herein by reference.

### FIELD OF THE INVENTION

The present invention relates generally to interactive television. More particularly, the present invention relates to a method and system for personalization and authorization of interactive television content.

### BACKGROUND OF THE INVENTION

Today, advancements in television systems provide a wide variety of services and applications for television users. One such advancement is interactive television (“iTV”). In an iTV environment, a TV user can interact with a broadcast or service being provided on the TV. For example, a broadcast may include enhanced, interactive content (“interactive content”) such as a Universal Resource Locator (URL) address in which a TV user can select to access a website or some other content on the Internet or World Wide Web at the selected URL address. Today, broadcasters send interactive triggers that are either accepted by a receiver or ignored based on compatibility of the interactivity with the receiver.

In current iTV systems, if a broadcaster broadcasts a program with interactive content, the interactive content must be broadcasted to all receivers of the program. Consequently, for such iTV systems, the broadcaster cannot control which receivers or users should receive the interactive content from a broadcast. Thus, a disadvantage with current iTV systems is that such systems do not provide personalization or authorization capabilities on a per receiver or per user basis.

### SUMMARY OF THE INVENTION

A method and system for personalization authorization of interactive television content are described. In one embodiment, interactive television (TV) content is tagged with one or more keys or personalization data. The tagged interactive TV content is transmitted to one or more receivers such that the receivers are to output (or make use of) selectively the interactive TV content based on the keys or personalization data.

Other features of the present invention will be apparent from the accompanying drawings and from the detailed description which follows.

### BRIEF DESCRIPTION OF THE DRAWINGS

The present invention is illustrated by way of example, and not limitation, in the figures of the accompanying drawings, in which like references indicate similar elements and in which:

FIG. 1A illustrates an exemplary interactive television system having a personalization and authorization platform architecture in which the present invention can be practiced;

FIG. 1B illustrates an exemplary screen shot of a TV broadcast including interactive TV content;

FIG. 2 illustrates a diagram of tagged interactive content according to one embodiment;

FIG. 3A illustrates a block diagram of the personalization and authorization platform architecture of FIG. 1 according to one embodiment;

FIG. 3B illustrates a block diagram of the personalization and tagging module of FIG. 3A according to one embodiment;

FIG. 4 illustrates a flow diagram of an operation for providing tagged interactive content according to one embodiment;

FIG. 5 illustrates a block diagram of the key/personalization data distribution system of FIG. 3A according to one embodiment;

FIG. 6 illustrates a flow diagram of an operation for providing keys to receivers according to one embodiment;

FIG. 7 illustrates a block diagram of the set-top box of FIG. 1 having a key and personalization filtering module according to one embodiment; and

FIG. 8 illustrates a flow diagram of an operation for filtering tagged interactive content for matching keys or personalization data according to one embodiment.

### DETAILED DESCRIPTION

A method and system for personalization and authorization of interactive television content are described. In one embodiment, interactive television (TV) content is tagged with one or more keys or personalization data. The tagged interactive TV content is transmitted to one or more receivers such that the receivers are to output or make use of selectively the interactive TV content based on the keys or personalization data.

By tagging interactive TV content with keys or personalization data, the interactive TV content can be filtered. The filtering process is not limited to any point within a broadcast. For example, the keys can be checked or filtered at a cable head-end system or within a TV subscribers set-top box or TV embedded device. The tagged keys or personalization data can be filtered or checked with delivered keys or personalization data to determine if the tagged interactive content is authorized for display or targeted for a particular receiver or group of receivers. If the tagged keys or personalization are authorized, the interactive content can then be displayed. Thus, content providers can target interactive content to specific receivers or users on a per receiver or per user basis. Content providers may also can target interactive content to specific groups of users by filtering some keys at regional head-end facilities.

In the following embodiments, interactive TV content can refer to any number of types of interactive TV content supported by a number of interactive content standards. For example, interactive TV content described herein can be based on the Advanced Television Enhancement Forum (ATVEV) standard for Transport Type A or Transport Type B, Internet Protocol (IP) Multicasting standard, Multi Protocol Encapsulation for Digital Video Broadcasting (DVB), or Broadcast Hypertext Markup Language (HTML) standards being developed for Digital Television (DTV).

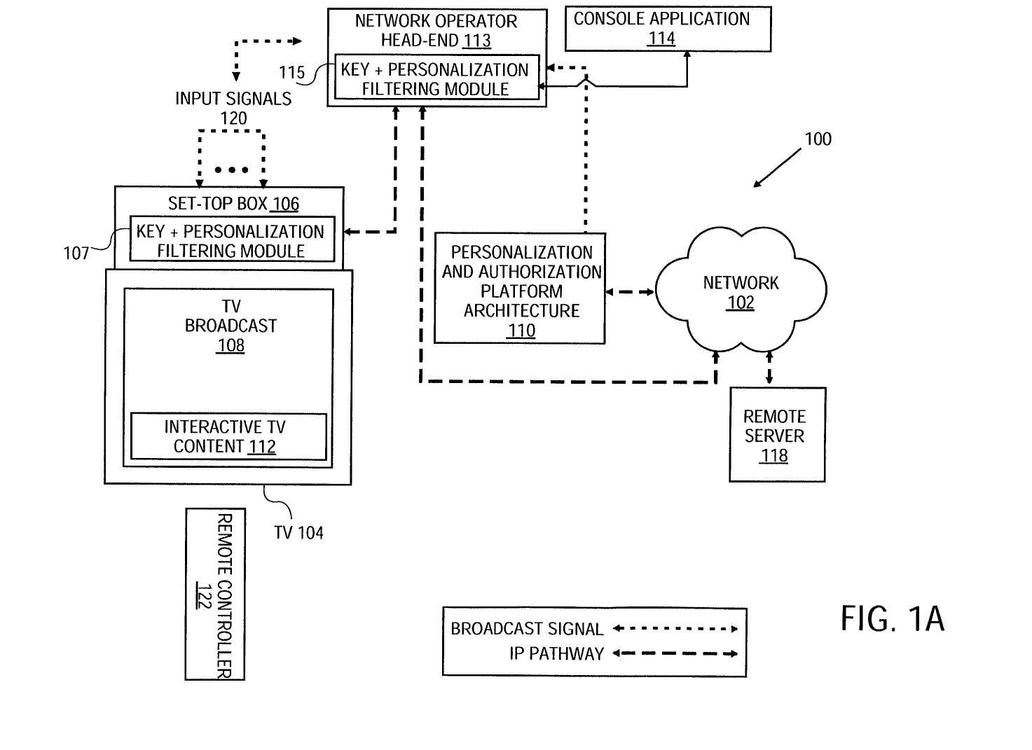

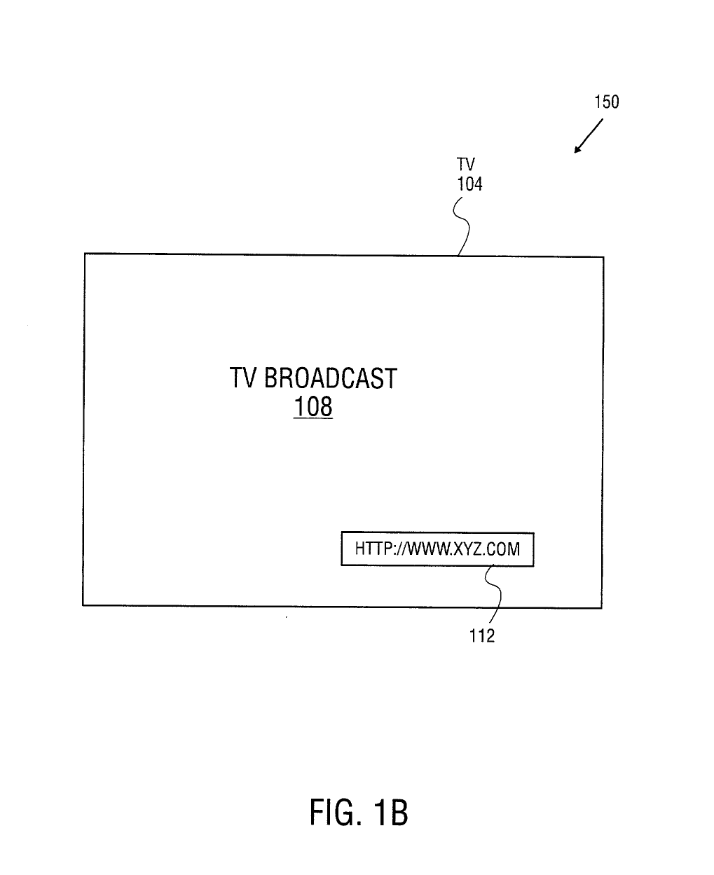

FIG. 1A illustrates an exemplary interactive television system 100 having a personalization and authorization platform architecture 110 in which the present invention can be practiced. Referring to FIG. 1, interactive television system 100 includes a set-top box 106 connected to a TV 104 (or embedded hardware within TV 104). Set-top box 106 and TV 104 can receive inputs from a remote controller 122. TV 104 is shown to have a network 102 connection capability. That is, TV 104 can be connected to network 102 via set-top box 106. Network 102 capability for set-top box 106 can be optional. Set-top box 106 can also be coupled to a network operator head-end 113.

Network operator head-end 113 includes a key and personalization filtering module 115, which can receive inputs from a console application 114. If there is not network 102 capability, the filtering techniques described herein for set-top box 106 or network operator head-end 113 filtering can be established either over the broadcast signal or directly by the user using the remote controller 122 or established by network operator head end 113 by network operator through console application 114.

In one embodiment, TV 104 can receive and display TV broadcast 108 with interactive TV content 112. Interactive TV content 112 can be used to retrieve information from remote server 118, e.g., a web server. For example, interactive TV content 112 can be enhanced, web-based content, which in included with TV broadcast 108. Set-top box 106 (or embedded hardware in TV 104) can receive or obtain interactivity through an Internet Protocol (IP) pathway. For instance, set-top box 106 can receive or obtain interactivity through a direct IP channel such as, for example, a telephone modem line, cable modem line, or xDSL line. Furthermore, interactivity can be obtained from the forwarded broadcast stream, e.g., TV broadcast 108 or from a local memory device or hard disk.

A broadcasst signal is shown with short dashed lines and can carry keyed (“tagged”) interactive content. The broadcast signal may also carry keys and personalization data for establishing filtering rules for the authorization and personalization data that will reside on set-top box 106. Such data will provide matching keys for incoming keyed interactive content. The broadcast signal or stream may also act as the IP pathway where IP over broadcast stream is supported. An IP pathway is shown with long dashed lines. The IP pathway may be used to update keys where the broadcast signal or stream may not be appropriate or may not be selective enough for the type of conversation or communication that is required. The IP pathway can also be used to retrieve interactive content.

Set-top box 106 is a receiver for TV 104. The components for set-top box 106 can be embedded hardware within TV 104. Set-top box 106 is compliant for some form of enhanced, interactive television content. For example, set-top box 106 can be compliant with the Advanced Television Enhancement Forum (ATVEF) standard for Transport Type A or Transport Type B for enhanced, interactive television content. ATVEF defines the standards used to create and deliver enhanced content for a number of mediums including analog (NTSC) or digital (ATSC) mediums from a number of sources such as, for example, terrestrial, cable, or satellite sources. TV 104 is a display device. TV 104 can support analog, Digital Video Broadcasting (DVB), Advanced Television Systems Committee (ATSC) or any of the other known TV standards.

Set-top box receives input signals 120 (e.g., television signals) to display on TV 104. Input signals 120 can be broadcast signals from a plurality of programming sources. For example, set-top box 106 can receive broadcast signals as input signals 120 from an antenna, cable, or satellite source. Input signals 120 can be analog or digital signals. Set-top box 106 can provide on-screen displays (OSDs) or graphical user interfaces (GUIs) to facilitate interactive services, e.g., accessing content on the Internet. As shown in FIG. 1A, set-top box 106 can be controlled by a user of remote controller 122. Alternatively, set-top box 106 can be controlled by other types of input devices such as, for example, an infrared (IR) keyboard.

Personalization and authorization platform architecture 110 can provide input for set-top box 106. In one embodiment, personalization and authorization platform architecture 110 provides set-top box 106 with a TV broadcast along with tagged interactive content as input for input signals 120. As will be described in further detail below, the tagged interactive content includes interactive content (e.g., interactive TV content 112) tagged with key data or personalization data in which set-top box 106 will use to output selectively the interactive content for display.

Personalization and authorization platform architecture 110 may also deliver keys or personalization data to key and personalization filtering module 107 within set-top box 106 for filtering purposes. Personalization and authorization platform architecture 110 may also deliver keys to key and personalization filtering module 115 within network operator head-end 113. Key and personalization filtering module 107 within set-top box 106 can communicate with key and personalization filtering module 115.

Key and personalization filtering modules 107 and 115 filter or check the tagged keys or personalization data with the delivered keys or personalization data from personalization and authorization platform architecture 110 to determine if the interactive content is authorized for display on TV 104. Additionally, key and personalization module 107 may include filtering keys or rules, which may be established directly by a user via remote control device 122 or by a provisioning network operator via an IP pathway. A network operator of network operator head-end 113 may also establish additional filtering keys or rules by updating the keys within key and personalization filtering module 115 via console application 114.

Personalization and authorization platform architecture 110 can be a computing system having multiple sub-systems for performing the personalization and authorization techniques described herein. Alternatively, personalization and authorization platform architecture 110 can include hardware and/or software modules operating within set-top box 106, or within systems operated of a TV network such as a cable head-end to perform the personalization and authorization techniques described herein.

Network 102 can represent a network such as the Internet hosting the World Wide Web (WWW). The WWW allows for a uniform way of accessing information on the Internet using HTML compliant browsers. Network 102 can be other types of networks such as, for example, a local area network (LAN) or a wide area network (WAN). Network 102 can also represent wired or wireless networks. Although one web server 102 is shown in FIG. 1A, any number of web servers can be connected to network 102. Furthermore, other types of network devices can also be connected to network 102, which can provide content for TV 104, such as, for example, a network router, bridge, gateway, or other like network devices.

Remote controller 122 is a control device for a user to provide inputs (e.g., infrared (IR) or radio frequency (RF) signals) to set-top box 106 and/or TV 104. Remote controller 122 can include alphanumeric keys, options keys, functions keys, and other like keys to operate set-top box 106 or TV 104. In one embodiment, a user can interact with interactive TV content 112 using remote controller 122. In particular, a user can access and navigate through a browser (not shown) operating on TV 104 by pressing selectively certain buttons or keys on remote controller 122. Interactive television system 100 can also be implemented in numerous configurations. For example, TV 104 can have the functionality of set-top box 106 contained internally. In addition, TV 104 can also be a computing device, which can display television signals.

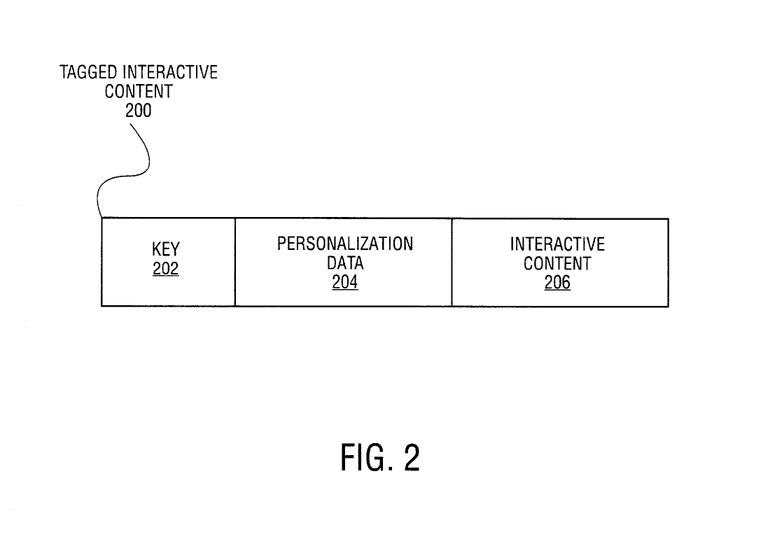

FIG. 1B illustrates an exemplary screen shot 150 of TV broadcast 108 including interactive TV content 112. Interactive TV content 112 can be selectively displayed with TV broadcast 108 based on tagged elements such as keys or personalization information as shown in FIG. 2, which will be described in more detail below. Referring to FIG. 1B, TV 104 displays TV broadcast 108 with interactive TV content 112. Interactive TV content 112 displays a Universal Resource Location (URL) location “http://www.xyz.com,” which is a location of an exemplary website on the Internet (or located locally on set-top box 108 or located within the forward broadcast stream, or located on some remove server 118) related to TV broadcast 108. For example, TV broadcast 108 may be a clothing store commercial and the exemplary URL location may the location of a website owned and operated by the clothing store. For example, the broadcaster may send two interactive triggers: one for male and one for female viewers/users.

Each trigger keyed according to gender. In one embodiment, set-top box 106 and other set-top boxes can accept the trigger that matches a local key attributed to the male gender, e.g., men watching a program or commercial selling mens clothing can be taken into an interactive experience related to the mens clothing. Likewise, the same can apply to the female gender in which a female viewer would click on the interactivity and be taken into an interactive experience, e.g., selling or buying clothing for women. Another example may be that only subscribers having paid a fee may experience the interactive service. In this case, the broadcaster (or network operator) have provided authorized viewers with an authorization key such that only authorized users may view the associated interactivity.

In one embodiment, interactive TV content 112 is based on an ATVEF trigger, but is not so limited. An ATVEF trigger is a data mechanism to alert receivers (e.g., set-top box 106) of incoming content enhancements. In particular, ATVEF triggers include information about enhancements that are available to the user. For example, the ATVEF trigger can include URL location as shown in FIG. 1B. The enhanced content can be broadcasted to set-top box 106. In one embodiment, the enhanced content may be already stored within set-top box 106. In another embodiment, the trigger may include readable description of content such as, for example, “press the browse button for more information about the product being advertised,” which can be displayed on TV 104 by set-top box 106. The trigger can also include JavaScript code. For example, the trigger can be used to execute another piece of JavaScript code within a webpage on the Internet. Because not all ATVEF capable set-top boxes have the same capabilities, another example of keyed interactive content may be that the broadcaster broadcasts different interactivity that is appropriate for different set-top box systems. In this case, the head-end filtering module (e.g., key and personalization filtering module 115) may filter the interactivity based on the types of set-top boxes that are deployed on their network.

FIG. 2 illustrates a diagram of tagged interactive content 200 according to one embodiment. Referring to FIG. 2, tagged interactive content 200 includes interactive content 206 tagged with personalization data 204 and key 202 as a single data unit. In one embodiment, interactive content 206 can be tagged with only key 202. In another embodiment, interactive content 206 can be tagged with only personalization data 204.

Interactive content 206 is enhanced, interactive television content. In one embodiment, interactive content 206 is delivered as the content for interactive TV content 112. Interactive content 206 is provided as interactive TV content 112 for display on TV 104 based on the authorization of the tagged key 206 or personalization data 204.

Personalization data 204 is data that is specific to a receiver or user. For example, personalization data 204 can include information detailing that all receivers or users within a geographical area or zip code are authorized to receive interactive content 206. Personalization data can also include information that indicates whether interactive content 206 can be displayed based on a customer purchasing a service to receive enhanced, interactive content. Key 202 can include one or more keys. Key 202 includes information that is used to determine if interactive content 206 is authorized for display.

As will be described in more detail below, the tagged elements of key 202 and/or personalization data 204 are used to augment interactive television broadcast content in which authorization and targeting capabilities can be provided for the interactive content.

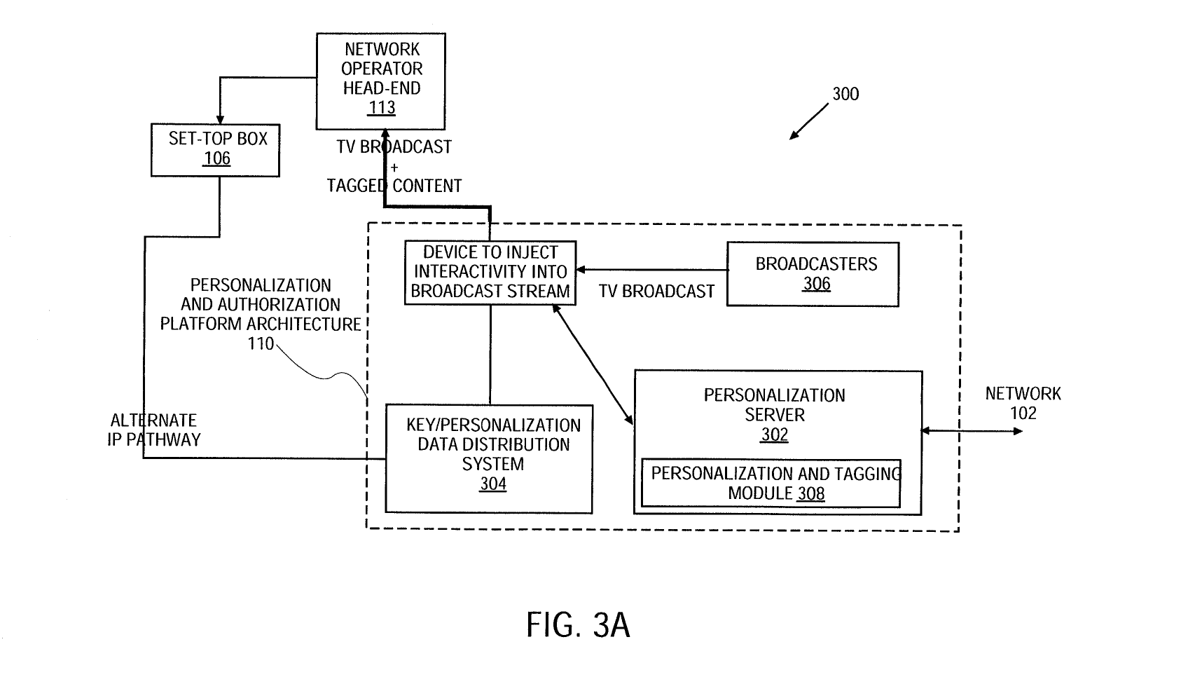

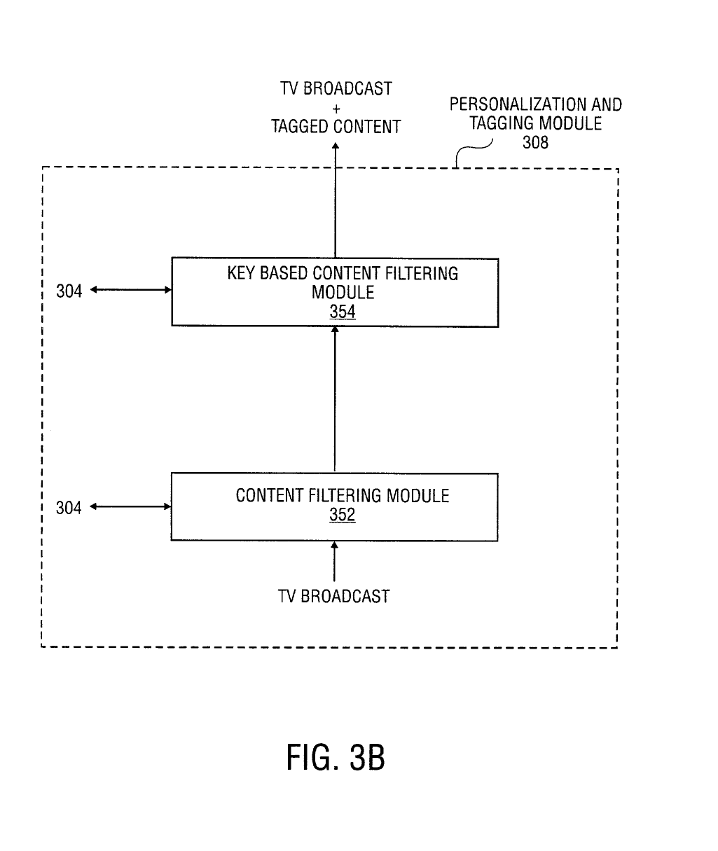

FIG. 3A illustrates a block diagram of the personalization and authorization platform architecture 110 of FIG. 1A according to one embodiment. Referring to FIG. 3A, personalization and authorization platform architecture 110 includes personalization server 302 coupled to a device to inject interactivity into a broadcast stream (device 310). Device 310 can receive a broadcast from broadcasters 306 or a key/personalization data distribution system 304.

Broadcasters 306 provide a TV broadcast to device 310 or to personalization server 302 via device 310. In one embodiment, broadcasters 306 package the TV broadcast with embedded, keyed interactivity and provide the TV broadcast for distribution. In the case for analog (over-the-air distribution), broadcasters 306 may provide a broadcast signal directly to antenna of receivers. In other cases, e.g., digital transmission, broadcasters 306 can provide a broadcast signal to network operators who then distribute the broadcast signal to viewers.

Network operators can send along the TV broadcasts using a number sources such as, for example, a satellite source, wireless Multipoint Microwave Distribution System (MMDS) source, digital subscriber line (DSL) source, cable modem source, or a video server and tape machine source. Broadcasters 306 can send live broadcasts, or, alternatively, pre-recorded broadcasts. In one embodiment, broadcasters 306 control the operation of personalization server 302 and key/personalization data distribution system 304 to include interactive TV content with a TV broadcast and to determine which receivers or users are to view the interactive TV content. Broadcasters 306 can use interactive television system 110 to prepare interactive content that can be targeted to specific receivers or viewers/users. Targeting can be done in conjunction with a network operator that carries the TV broadcast signal to destination receivers or can be done directly with the receivers where there is a IP pathway available for communication between broadcasters 306 and set-top box 106 device.

Personalization server 302 can be a general purpose computing system, workstation, or client server. Personalization server 302 is responsible for including interactive content with a TV broadcast. Personalization server 302 includes a personalization and tagging module 308 that tags interactive content 206 with key 202 and/or personalization data 204. In one embodiment, personalization and tagging module 308 is client/server software components, frameworks, or turnkey applications to operate in an interactive TV environment.

Personalization and tagging module 308 can be configured or programmed to determine if interactive content 206 is to be tagged with key 202 or personalization data 204 based on instructions from key/personalization data distribution system 304 for delivery with TV broadcast 108. Personalization and tagging module 308 receives key 202 and/or personalization data 204 from key/personalization data distribution system 304. Personalization and tagging module 308 uses a filtering process to determine if interactive content 206 is to be tagged with key 202 and/or personalization data 204 as will be described in further detail below. Personalization and tagging module 308 also tags interactive content 206 with key 202 and/or personalization data 204 if instructed to do so.

Key/personalization data distribution system 304 is a system of one more general purpose computing systems, workstations, or client servers and databases. Key/personalization data distribution system 304 is responsible for the administering and provisioning of keys and personalization data for interactive television system 100. In one embodiment, key/personalization distribution system 304 is responsible for providing key 202 and/or personalization data 204 to personalization server 302 and/or set-top box 106.

For example, key/personalization distribution system 304 can send a key “1 ” to personalization server 302 with instructions to tag key 1 with interactive content that is to be sent to set-top box 106. Key/personalization distribution system 304 can also send a matching key “1” to set-top box 106. Set-top box 106 can be programmed or configured through key and personalization filtering module 107 to check or match the keys in allowing (“authorizing”) interactive content 206 having a key 1 tagged to it for display on TV 104.

FIG. 3B illustrates a block diagram of the personalization and tagging module 308 of FIG. 3A according to one embodiment. Referring to FIG. 3B, personalization and tagging module 308 includes content filtering module 352 and key based content filtering module 354, which are both coupled to key/personalization data distribution system 304. Content filtering module 352 and key based content filtering module 354 are sub-modules or components of personalization and tagging module 308.

Content filtering module 352 is used to perform a first stage filtering process of a TV broadcast. In one embodiment, a network operator or broadcaster can control whether interactive content is to be included with the TV broadcast. For example, the network operator or broadcaster can specify if interactive content is to be included based personalization data (e.g., date and time or geographical area). In such an example, a network operator or broadcaster can provisionally allow interactive content to be added to a TV broadcast at a given date and time or for a given geographical area. In other examples, a broadcast content creator, broadcast network provider, or broadcast affiliate can also be allowed to instruct content filtering module 352 to add interactive content to the TV broadcast. Such interactive content can be locally stored in personalization server 302 or be delivered by key/personalization data distribution system 304.

Key based content filtering module 354 is used to perform a second stage filtering process of the TV broadcast with interactive content. In this stage, a tagging process can be performed on the interactive content. For example, tagging interactive content 206 with key 202 and/or personalization data 204. Key based content filtering module 354 can communicate with key/personalization data distribution system 204 to receive specific keys and/or personalization data (e.g., key 202 and/or personalization data 204) for tagging interactive content (e.g., interactive content 206). Such keys and personalization data are to be used to match with keys and/or personalization data delivered to set-top box 106. Set-top box 106 performs a third stage filtering process to determine if key 202 and/or personalization data 204 are authorized or valid for interactive content 206.

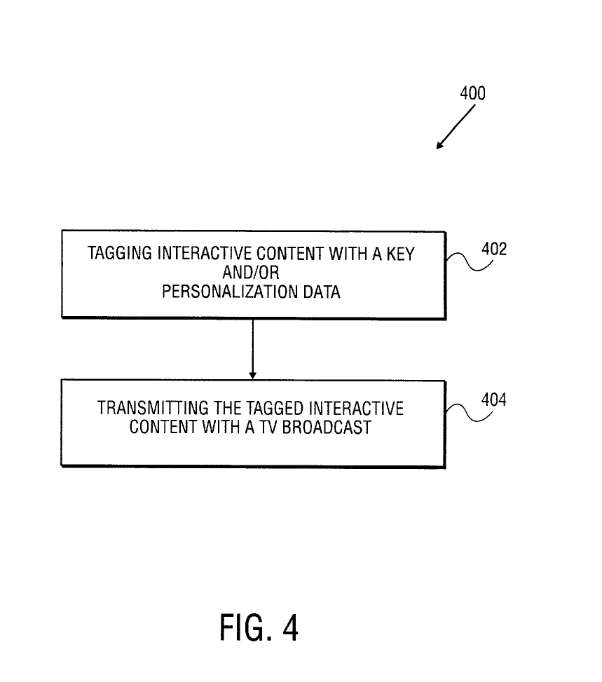

FIG. 4 illustrates a flow diagram of an operation 400 for providing tagged interactive content according to one embodiment. Initially, operation 400 begins at operation 402.

At operation 402, interactive content is tagged with a key and/or personalization data. For example, personalization and tagging module 308 can be instructed to tag interactive content 206 with just key 202. Alternatively, personalization and tagging module 308 can be instructed to tag interactive content 206 with just personalization data 204 or both.

At operation 404, the tagged interactive content 200 is transmitted to one or more receivers with a TV broadcast. For example, personalization server 302 can broadcast tagged interactive content 200 to set-top box 106. Set-top box 106 will then perform a filtering process (as will be explained below) to determine if the authorized or right key 202 and/or personalization data 204 is associated with interactive content 206.

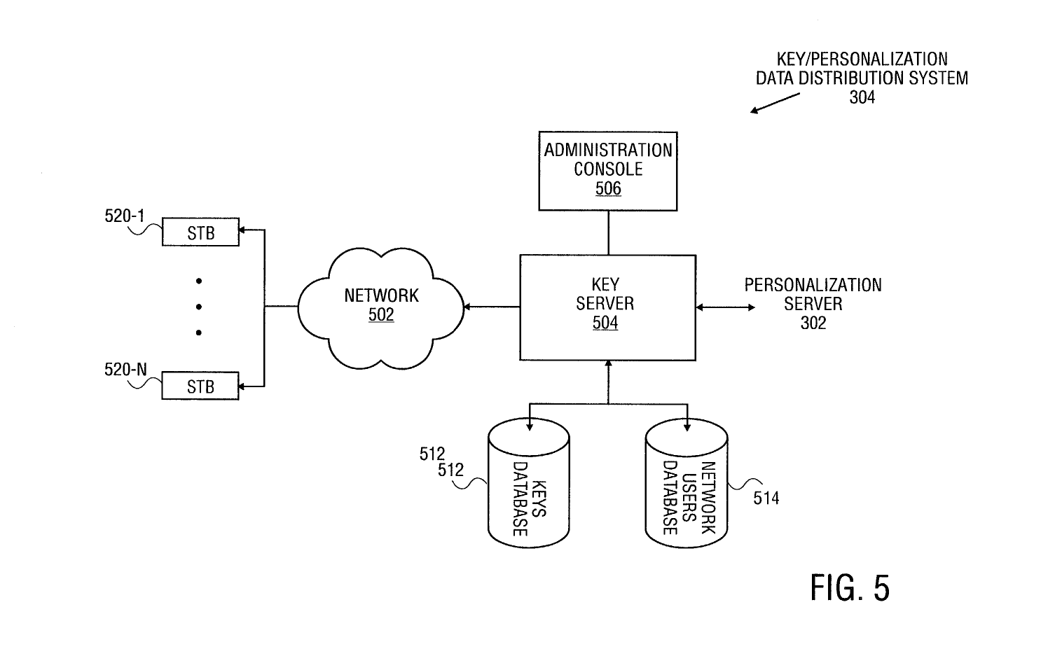

FIG. 5 illustrates a block diagram of the key/personalization data distribution system 304 of FIG. 3A according to one embodiment. The example of FIG. 5 describes how broadcasters 306 can maintain a database of key and personalization attributes. In one embodiment, between key server 504 and network 502, a network operator may be positioned, and is responsible for carrying signals to set-top boxes such as set-top box 106.

Referring to FIG. 5, key/personalization data distribution system 304 includes a key server 504 coupled to keys database 512 and network users database 514. Key server 504 can be controlled and operated by a user via administration console 506. Key server 504 is coupled to a plurality of receivers or set-top boxes (STB) 520-1 through (STB) 520-N via network 502. One of the pluralities of receivers STB 520-1 through STB 520-N can be set-top box 106.

Key server 504 can be a general purpose computing system, workstation, or client server. Key server 504 is responsible for managing and distribution of keys stored in keys database 510 and personalization data stored in network users database 514. Keys database 512 and network users database 514 can store relationship information for keys tagging interactive content and keys being delivered to STB 520-1 through STB 520-N for matching or authorizing the tagged keys and personalization data.

In one embodiment, key 202 is stored in keys database 512 and personalization data 204 is stored in network users database 514. Interactive content 206 can be stored in keys database 512 and/or network users database 514. A user via administration console 506 can operate key server 504 to associate specific keys in keys database 512 with specific keys being used for tagging interactive content and specific keys being delivered to STB 520-1 through STB 520-N. Furthermore, a user via administration console 506 can operate key server 504 to associate specific personalization data in network users database 514 being used for tagging specific interactive content and specific personalization data being delivered to STB 520-1 through STB 520-N. Key server 504 can also update or add keys and personalization data to the databases.

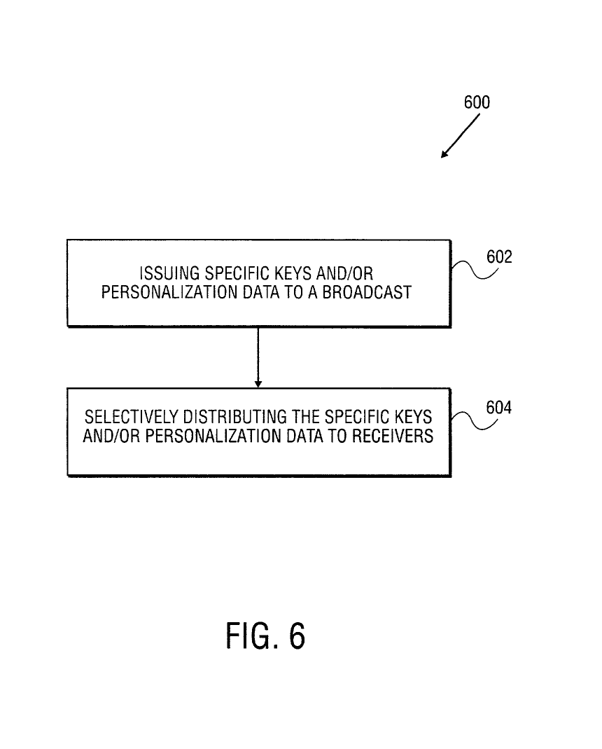

FIG. 6 illustrates a flow diagram of an operation 600 for providing keys to receivers according to one embodiment. Initially, operation 600 begins at operation 602.

At operation 602, specific keys and/or personalization data are issued to a broadcaster. For example, key/personalization data distribution system 304 can issue a specific key “A” and specific personalization data (e.g., allow interactive content for display on specific date and time) to be tagged with interactive content “X” to one of the broadcasters 306. The broadcaster can then instruct personalization server 302 to tag interactive content with specific key “A” and the specific personalization to allow interactive content for display on the specific date and time.

At operation 604, the specific keys and/or personalization data are selectively distributed to the receivers. For example, key/personalization data distribution system 304 can match specific key “A” with a specific key “B” for authorization purposes within STB 520-1 through STB 520-N. Thus, key/personalization data distribution system 304 will send specific key “B” and the specific personalization data to allow interactive content for display at the specific date and time to STB 520-1 through 520-N. If interactive content having specific key that matches key “B,” the STB 520-1 through 520-N will allow the interactive content to be displayed at the specific data and time specified by the delivered personalization data.

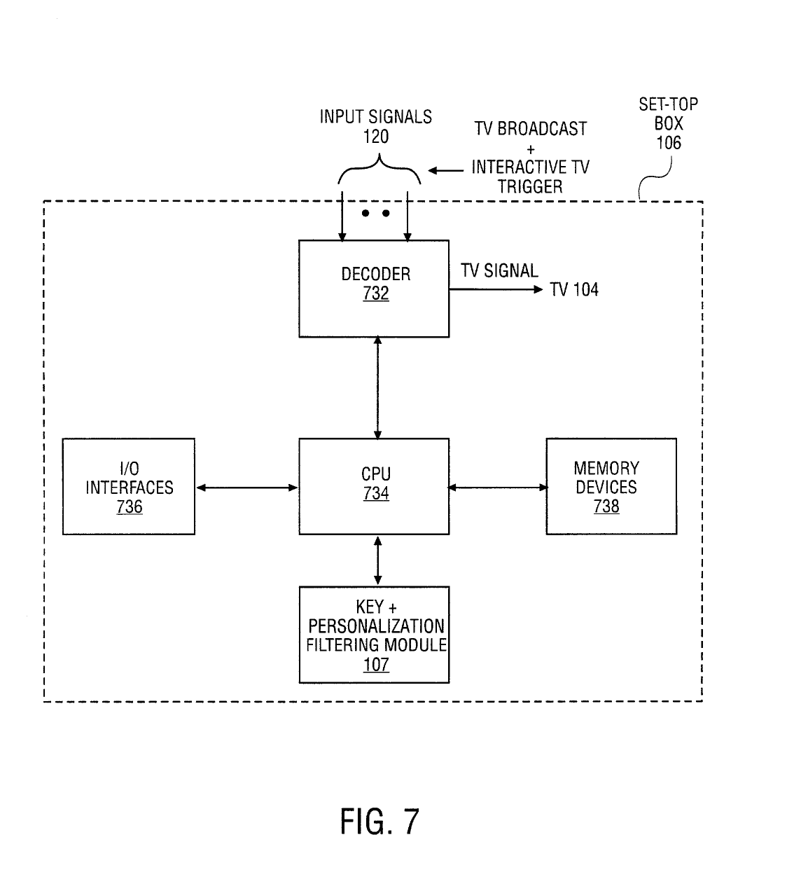

FIG. 7 illustrates a block diagram of the set-top 106 box of FIG. 1 having a key and personalization filtering module 107 according to one embodiment. Set-top box 106 can represent STB 520-1 through STB 520-N shown in FIG. 5. For purposes of clarity, only the basic components of set-top box 106 are shown in block diagram form. Set-top box 106 is configured to provide enhanced, interactive television content services.

Referring to FIG. 7, set-top box 106 includes a central processing unit (CPU) 734 coupled to memory devices 738, input/output (I/O) interfaces 736, decoder 732, and key and personalization filtering module 107. Decoder 702 can receive inputs signals 120. In one embodiment, one of the input signals 120 is a TV broadcast with tagged interactive content. The integrated content can be enhanced, interactive television content. Decoder 732 can receive input signals 120 as analog (NTSC) or digital (ATSC) signals from a number sources including terrestrial, cable, and satellite sources. Decoder 732 outputs a TV signal to TV 104, which can be enhanced with the integrated content as described herein.

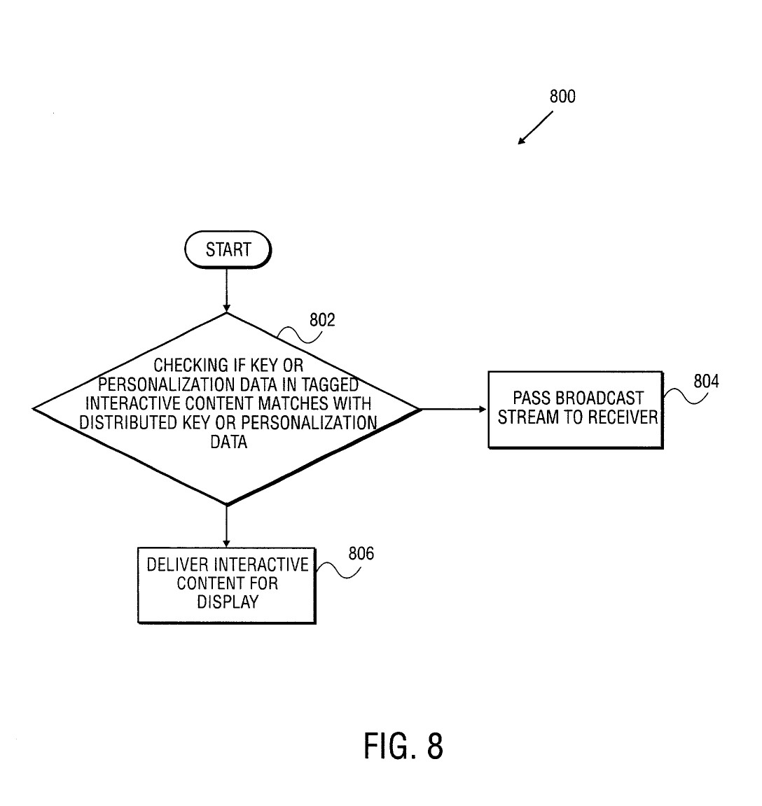

CPU 734 is the central control mechanism for set-top box 106. CPU 734 can execute code or instructions stored in memory devices 738 or stored in key and personalization filtering module 107 or external storage devices via network 102. For example, I/O interfaces 736 may include a connection to network 102 provided by a dial-up modem. I/O interfaces 136 can also include an (IR) or (RF) interface for receiving inputs from remote controller 122. CPU 734 can execute code or instructions to authorize decoder 732 to output interactive content 206 as interactive TV content 112 on TV 104. For example, CPU 734 can execute software modules within key and personalization filtering module 107 to perform the operation as described in FIG. 8.

Key and personalization filtering module 107 includes hardware and/or software modules to process keys and/or personalization data delivered from key/personalization data distribution system 304. Key and personalization filtering module 107 checks or matches delivered keys and/or personalization data with corresponding tagged keys and/or personalization data with interactive content. If the keys and/or personalization data match, key and personalization filtering module 107 instructs or authorizes STB 106 to display the interactive content.

In one example, set-top box 106 can receive multiple versions of interactive content for a broadcast enhancement and key and personalization filtering module 107 can determine which enhancement best matches the attributes of the viewer of set-top box 106 or any given STB, and the enhancements can be discarded. In another example, to view broadcast enhancements, a fee may be required in which case appropriate keys and/or personalization data is provided to authorize display of the interactive content.

Memory devices 738 can include a machine-readable medium that provides (i.e., stores and/or transmits) information in a form readable, e.g., by CPU 134. Memory devices 308 may include a read only memory (ROM), random access memory (RAM), magnetic disk storage media, optical storage media, or flash memory devices. The code or instructions stored in memory devices 138 can be represented by carrier wave signals, infrared signals, digital signals, and by other like signals.

FIG. 8 illustrates a flow diagram of an operation 800 for filtering tagged interactive content for proper keys or personalization data according to one embodiment. Initially, operation 800 begins at operation 802.

At operation 802, a check is made if tagged key or personalization data with interactive content matches with distributed key or personalization data. For example, key and personalization filtering module 107 can check keys or personalization data delivered from key/personalization distribution system 304 with the tagged keys or personalization data.

At operation 804, if the tagged key or personalization data does not match the delivered key or personalization data, the interactive content within the tagged interactive content is discarded.

At operation 806, if the tagged key or personalization data does match the distributed key or personalization data, the interactive content is delivered for display. For example, interactive content 206 can be displayed as interactive TV content 112 on TV 104.

The above embodiments describe techniques to target specific receivers and/or users for authorization to display enhanced, interactive TV content. In particular, a broadcaster may key interactive data such that particular head-ends or individual set-top boxes can choose to use or ignore interactivity based on a variety of parameters. For example, demographic parameters can be used to determine which region interactivity is targeted or what types of technology are supported within a given head-end.

Authorization on whether a user has rights to view or use such interactivity may be based on a user payment requirement. Authorization may also be based on personalization information, e.g., has the user requested to see this type of interactivity. Furthermore, a broadcaster can send many interactive triggers for a single event with differing keys such that only the right keyed interactivity makes it through a filtering process to particular set-top boxes.

Thus, a method and system for personalization and authorization of interactive television content have been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative sense rather than a restrictive sense.

What is claimed is:

1. In an interactive television (TV) environment, a method for providing interactive TV content comprising:
tagging interactive TV content with one or more keys or personalization data; and
transmitting the tagged interactive TV enhancement to one or more receivers such that the receivers are to output or make use of selectively the interactive TV content based on the keys or personalization data.

2. The method of claim 1, further comprising:
receiving the keys or personalization data.

3. The method of claim 1, further comprising:
delivering one more keys or personalization data to the receivers or to one or more network system nodes.

4. The method of claim 3, further comprising:
checking the keys or personalization data within the transmitted tagged interactive TV content with the delivered keys or personalization data, the checking to be performed by the receivers via use of a remote control or directly at a network system node using a console application.

5. The method of claim 4, further comprising:
displaying the interactive TV content within the tagged interactive content based on the checked keys or personalization data.

6. An interactive television (TV) system comprising:
a tagging module to tag interactive TV content with one or more keys or personalization data; and
a transmitting unit to transmit the tagged interactive TV enhancement to one or more receivers such that the receivers are to output selectively the interactive TV content based on the keys or personalization data.

7. The system of claim 6, wherein the tagging module is to receive the keys or personalization data.

8. The system of claim 6, further comprising:
a distribution system to deliver one or more keys or personalization data to the receivers.

9. The system of claim 8, further comprising:
a filtering module in network system nodes or in receivers to check the keys or personalization data within the transmitted tagged interactive TV content with the delivered keys or personalization data.

10. The system of claim 9, wherein the filtering module allows the interactive TV content within the tagged interactive content to be displayed, or passed along to the next network system node, based on the checked keys or personalization data.

11. A receiver comprising:
a decoding unit to receive a broadcast with tagged interactive content, the tagged interactive content including one or more keys or personalization data and interactive content, and to output selectively the interactive content with the broadcast for display; and
a key and personalization filtering module to receive keys or personalization data, to check if the received keys or personalization data match with the tagged keys or tagged personalization data, and, if the keys or personalization data match, to allow the decoding unit to output the interactive content with the broadcast for display.

12. The receiver of claim 11, wherein the key and personalization filtering module is to receive the keys or personalization data via a network.

13. A machine-readable medium providing instructions, which if executed by a processor, causes the processor to perform an operation comprising:
tagging interactive TV content with one or more keys or personalization data; and
transmitting the tagged interactive TV enhancement to one or more receivers such that the receivers are to output selectively the interactive TV content based on the keys or personalization data.

14. The machine-readable medium of claim 13, further providing instructions, which if executed by the processor, causes the processor to perform an operation comprising:
delivering one more keys or personalization data to the receivers.

15. A machine-readable medium providing instructions, which if executed by a processor, causes the processor to perform an operation comprising:
checking tagged keys or personalization data associated with received interactive TV content with delivered keys or personalization data; and
displaying the interactive TV content if the checked keys or personalization data match with delivered keys or personalization data.

16. In an interactive television environment, a personalization and authorization platform architecture comprising:
a personalization server to receive a television (TV) broadcast, to include interactive content with the TV broadcast, and to tag the interactive content with one or more keys and/or personalization data; and
a key and personalization distribution system to provide the keys and and/or personalization data to the personalization server, and to deliver matching keys and/or personalization data to on or more receivers.

17. The personalization and authorization platform architecture of claim 16, wherein the receivers are to receive the TV broadcast with the tagged interactive content, to check if the tagged keys and/or personalization data match with the matching keys and/or personalization data.

18. The personalization and authorization platform architecture of claim 16, wherein the receivers are to output the interactive content if the tagged keys and/or personalization data match with the matching keys and/or personalization data.

19. The personalization and authorization platform architecture of claim 16, wherein a broadcaster or network operation determine which TV broadcast to include interactive content.

20. The personalization and authorization platform architecture of claim 16, wherein the broadcaster or network operator determine which keys and/or personalization data to use to tag the interactive content.
